(19) United States
(12) Patent Application Publication
(10) Pub. No.: US 2008/0156717 A1
(43) Pub. Date: Jul. 3, 2008

(54) FLUID FLOW DIRECTOR FOR WATER TREATMENT SYSTEM

(75) Inventors: Liane B. Hopaluk, Lowell, MI (US); Terry L. Lautzenheiser, Nunica, MI (US)

Correspondence Address: WARNER, NORCROSS & JUDD;IN RE: ALTICOR INC., INTELLECTUAL PROPERTY GROUP, 111 LYON STREET, N. W. STE 900, GRAND RAPIDS, MI, 49503-2489, US

(73) Assignee: ACCESS BUSINESS GROUP INTERNATIONAL LLC, Ada, MI (US)

(21) Appl. No.: 11/948,241

(22) Filed: Nov. 30, 2007

Related U.S. Application Data
(60) Provisional application No. 60/868,995, filed on Dec. 7, 2006.

(51) Int. Cl. B01D 15/04; B01D 27/00; B23P 11/00

(52) U.S. Cl. 210/282; 210/263; 29/428

(57) ABSTRACT

A plastic fluid flow director for a water treatment system is provided having a plastic substrate with a protective coating that is substantially opaque to UV light. The plastic substrate may be ultra-high molecular weight polyethylene and the UV opaque coating may be unexpanded polytetrafluoroethylene (“PTFE”). The UV opaque coating protects the plastic substrate from UV light, which may be destructive to the plastic, during the water treatment process. The coating is suitable for water contact, does not break down in the presence of ultraviolet light for extended periods, and otherwise works with conventional water treatment systems. The plastic substrate with UV opaque coating is a suitable replacement for a stainless steel fluid flow director.

### RELATED APPLICATIONS

This application claims priority to and benefit of U.S. Provisional Application No. 60/868,995, entitled Fluid Flow Director for Water Treatment System, by Liane Hopaluk et al, filed Dec. 7, 2006.

### BACKGROUND OF THE INVENTION

The present invention relates to water treatment systems and more particularly to fluid flow directors for use in water treatment systems in the presence of ultraviolet (UV) light.

Water treatment systems for filtering and treating contaminants in water are known. Many water treatment systems employ a fluid flow director or baffle in the water path to deflect, divert, check, regulate, or otherwise manipulate the flow or passage of water through the water treatment system. Because the fluid is in contact with the fluid flow director, the fluid flow director is typically manufactured from a material that will not leach impurities or otherwise taint the water. Often, these fluid flow directed are located in the presence of UV light. UV light has an inherent tendency to break down or otherwise adversely impact a range of materials, including many plastics. To avoid tainting the water and to withstand the UV light used in these water treatment systems, the fluid flow director is commonly made from stainless steel because of its physical properties and chemical inertness. Unfortunately, stainless steel is relatively expensive and results in a material increase in the overall cost of the water treatment system. In some applications, the fluid flow director is installed in a disposable filter cartridge. Accordingly, the stainless steel fluid flow director is replaced each time the filter cartridge is replaced. This compounds the cost issues associated with the use of stainless steel.

Accordingly, there is an unmet need for an inexpensive alternative to a stainless steel fluid flow director that will not adversely affect water quality and will withstand prolonged exposure to UV light.

### SUMMARY OF THE INVENTION

The aforementioned problems are overcome by the present invention which provides a fluid flow director (or baffle) having a plastic substrate with a protective coating that is substantially opaque to UV light. In one embodiment, the plastic substrate is polyethylene and the UV opaque coating is polytetrafluoroethylene (“PTFE”).

The UV opaque coating protects the plastic substrate from UV light, which may be destructive to the plastic. In addition, the coating is suitable for water contact, does not break down in the presence of ultraviolet light for extended periods, does not cause any foul odors or tastes, can withstand an appropriate amount of outside water pressure, and substantially meets all other structural requirements for the rated life of an otherwise conventional water treatment system.

The plastic substrate with UV opaque coating is a suitable replacement for a stainless steel fluid flow director and is significantly less expensive. Accordingly, the plastic substrate with UV opaque coating provides a cost effective solution that does not diminish the quality or performance of the water treatment system.

These and other objects, advantages, and features of the invention will be readily understood and appreciated by reference to the detailed description of the current embodiment and the drawings.

### BRIEF DESCRIPTION OF THE DRAWINGS

FIG. 1 is a sectional view of one embodiment of a water treatment system employing a fluid flow director made of a plastic substrate with a UV opaque coating.

FIG. 2 is an exploded perspective view of the water treatment system shown in FIG. 1.

FIG. 3 is an exploded perspective view of the filter cartridge of the water treatment system shown in FIG. 1.

FIG. 4 is an end view of the filter cartridge shown in FIG. 3.

FIG. 5 is a sectional view of the filter cartridge taken along line A-A of FIG. 4.

FIG. 6 is a sectional view of the filter cartridge taken along line B-B of FIG. 4.

FIG. 7 is an enlarged sectional view of area C in FIG. 5 showing the open end cap interface.

FIG. 8 is an enlarged sectional view of area D in FIG. 5 showing the closed end cap interface.

FIG. 9 is an end view of the fluid flow director of the filter cartridge shown in FIG. 3.

FIG. 10 is an enlarged partial view of the fluid flow director shown in FIG. 9.

### DESCRIPTION OF THE CURRENT EMBODIMENT

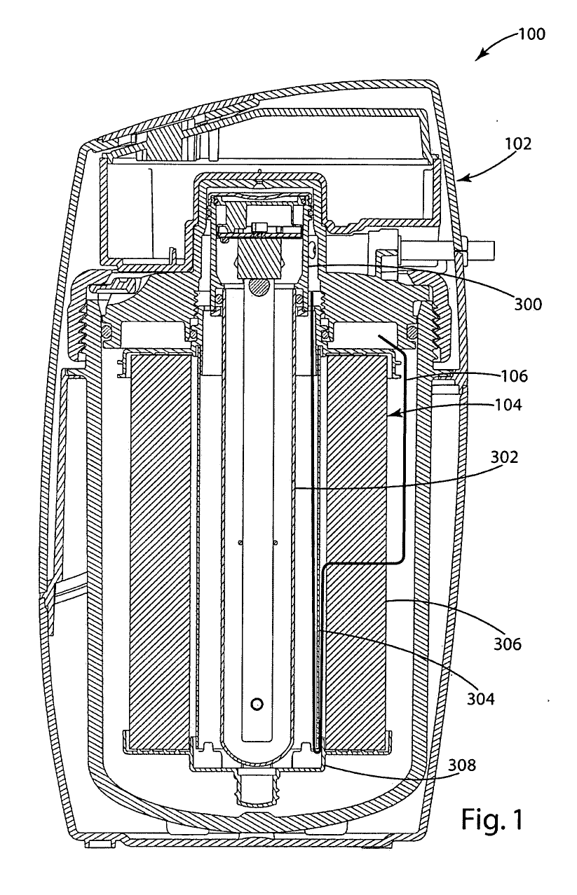

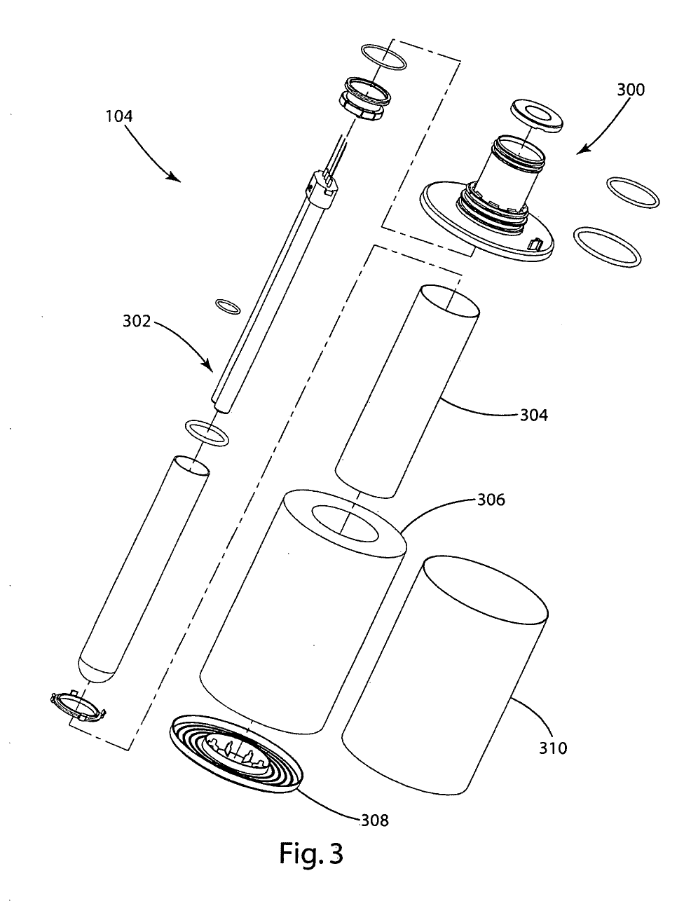

A water treatment system in accordance with an embodiment of the present invention is shown in FIG. 1 and generally designated 100. In this embodiment, the water treatment system generally includes a base unit 102 and a filter cartridge 104. A filter cartridge 104 in accordance with an embodiment of the present invention is shown in FIG. 3. The filter cartridge 104 of this embodiment includes, among other things, an ultraviolet (UV) light assembly 302 and a plastic fluid flow director 900 with a UV opaque coating 902, generally designated 304. The UV opaque coating 902 of the described embodiment is made from unexpanded polytetrafluoroethylene (“PTFE”) and protects the plastic 900 from being harmed by the UV light. The present invention is described within the context of a particular water treatment system. The present invention is, however, generally well-suited for use within essentially any other water treatment system.

Water treatment systems including stainless steel fluid flow directors are known. Replacing the stainless steel fluid flow director with a plastic fluid flow director with a UV opaque coating does not substantially alter the way in which the water treatment system works. Accordingly, the water treatment system generally is not described in great detail. Although operation of the water treatment system is not described in great detail, a more detailed description of the operation and construction of a water treatment system is presented in U.S. Pat. No. 6,451,202, issued Sep. 17, 2002 to Kuennen et al, which is hereby incorporated by reference.

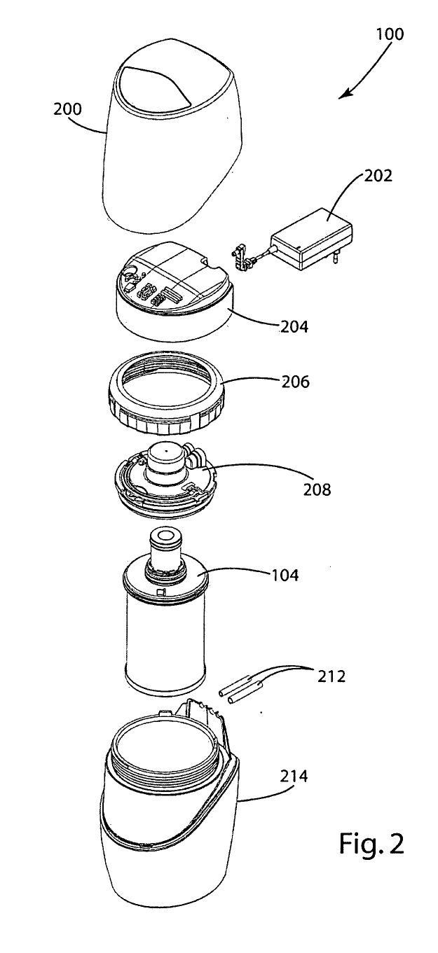

As noted above, the water treatment system 100 includes a base unit 102 and a filter cartridge 104. The components of the base unit 102, likely best shown in FIG. 2, include a top shroud 200, a power adaptor 202, an electronic module 204, a collar 206, a filter bracket 208, tubing 212, and a bottom shroud 214. The top shroud 200 and bottom shroud 214 cooperate to house the inner workings of the water treatment system. The power adapter 202 connects from a power outlet (not shown) to the electronic module 204 to power the water treatment system. The electronic module 204 includes electronics which allow the operation of the water treatment system. The collar 206 and filter bracket 208 assist in keeping the removable filter cartridge 104 seated in place during operation. Additionally, the filter bracket 208 and tubing 212 direct the flow of water into and out of the water treatment system.

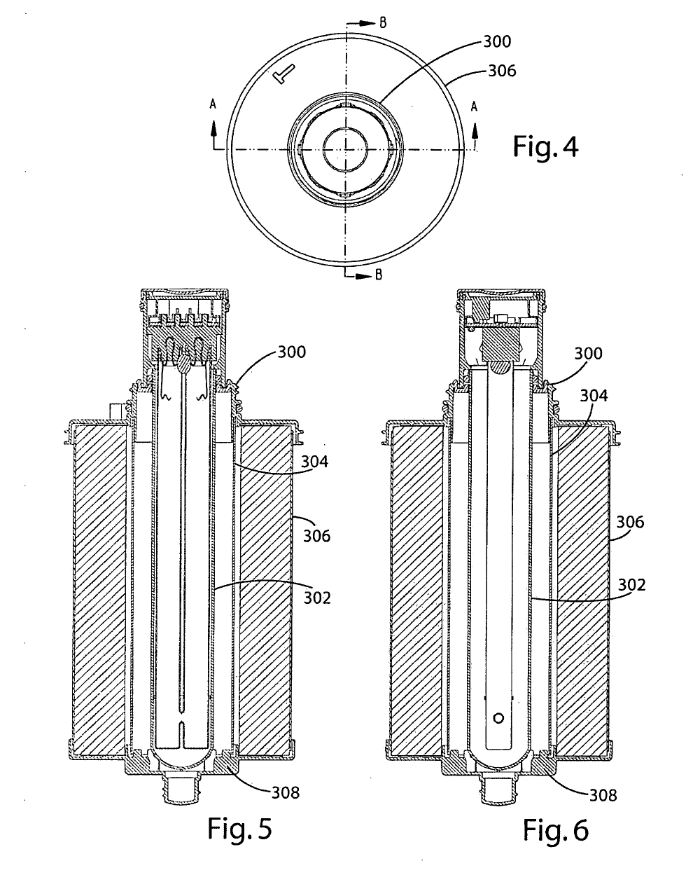

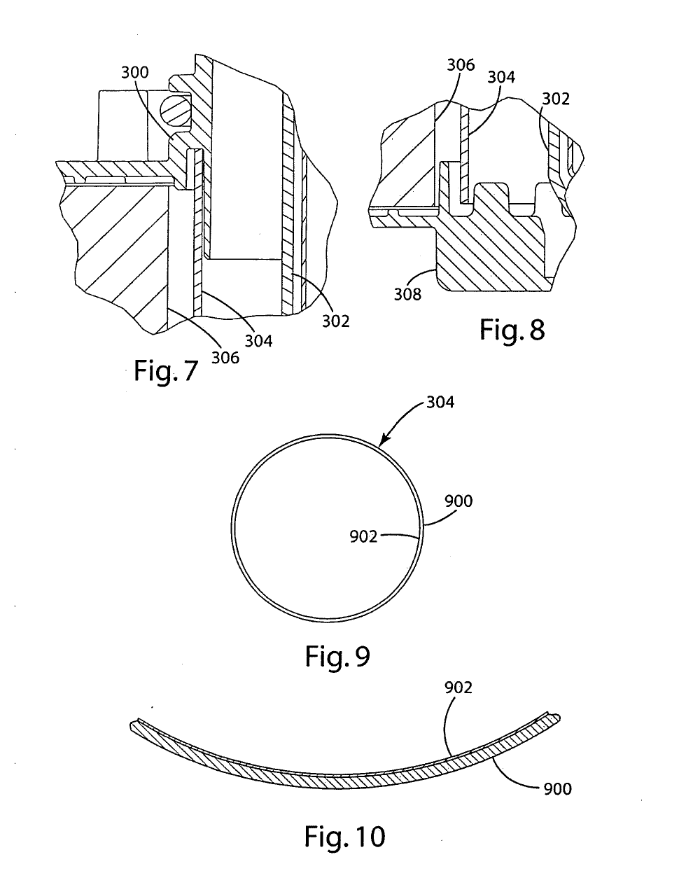

The components of the filter cartridge 104 are likely best shown in FIG. 3 and include an open end cap 300, a UV light assembly 302, a fluid flow director made of a plastic substrate with a UV opaque coating 304, a carbon filter 306, and a closed end cap 308, and an optional supplemental filter 310. The assembled filter cartridge generally is shown in FIGS. 4-6. The UV light assembly 302, fluid flow director 304 and filter 306 coaxially interfit with the closed end cap 300, likely best shown in FIG. 7, such that there is a substantially cylindrical ring of space that separates the UV light assembly 302 from the fluid flow director 304 and a substantially cylindrical ring of space that separates the fluid flow director 304 from the filter 306. The fluid flow director 304 and filter 306 also coaxially interfit with the closed end cap 308, likely best shown in FIG. 8, such that as water passes through the filter 306 it is diverted toward the closed end cap 308. In the current embodiment, the fluid flow director is glued in place to the closed end cap 308. The optional supplemental filter 310 is wrapped around filter 306. The supplemental filter may be made from a non-woven material, such as plastic fiber. One suitable material for the supplemental filter 310 may be polypropylene.

The flow of water through the current embodiment of the water treatment system is shown in FIG. 1 as arrow 106. The water is fed to the tank through tubing 212 where it makes its way through the carbon filter 306. After the water passes through the carbon filter 306 the water is directed by the fluid flow director 304 towards the closed end cap 308. Upon reaching the closed end cap 308 water is allowed into the space between the UV light assembly 302 and the fluid flow director 304 for disinfection. After disinfection, the water is routed out of the water treatment system through tubing 212.

The shape, size, composition and other characteristics of the fluid flow director 304 made from a plastic substrate with a UV opaque coating may vary from application to application. In the described embodiment, the plastic substrate is ultra-high molecular weight polyethylene and the UV opaque coating is unexpanded polytetrafluoroethylene (“PTFE”). In the current embodiment, the plastic substrate with UV opaque coating is shaped and sized as an open ended tube to interfit with the closed end cap 308 and the open end cap 300. The PTFE material of the current embodiment is Mupor™ Microporous PTFE available as part no. PM3VR from Porex Corporation at 500 Bohannon Road, Fairburn, Ga. 30213. The thickness of the PTFE material is believed to directly affect transparency and therefore the amount of protection provided from UV light. In the current embodiment, the PTFE coating is 8.5 mils thick. Spectrophotometer testing shows this thickness of PTFE to be sufficiently opaque to the UV wavelength of the current embodiment, 254 nanometers. The polyethylene and PTFE may be obtained already laminated, formed into a tube, welded, and cut to length as desired, available as part no. 41192 also from Porex Corporation.

The shape, size, composition and other characteristics of the plastic substrate and UV opaque coating are merely illustrative and are not intended to be limiting. For example, in some applications the plastic substrate may alternatively be manufactured from high or low density polyethylene and other similar polymeric materials. In applications where a coating of greater UV opacity is applied, it may be possible to use substrate materials with a lesser degree of resistance to damage from UV light. Also, the thickness or number of layers of the PTFE coating may be selected to control the opacity depending on the particular UV wavelength. As used herein, the term “opaque” is not intended to refer to absolute opacity, but rather is intended to denote a sufficient amount of opacity so as to protect the underlying substrate from an undesirable amount of decay over the life of the fluid flow director.

In the illustrated embodiment, the UV opaque coating 902 is applied to a single surface of the substrate 900. Where desired, the UV opaque coating 902 may be applied to multiple surfaces. For example, in applications where multiple surfaces of the substrate 900 are subjected to UV light, each of the surfaces impacted by UV light may be coated with a UV opaque coating. The characteristics of the UV opaque coating may vary from surface to surface (or region to region) as dictated, for example, by the severity of UV exposure.

Although the invention has been described with respect to the illustrated water treatment system, it should be understood that the invention could be implemented in essentially any water treatment system where it is desirable to dispose a fluid flow director or baffle in the presence of UV light. The above description is that of the current embodiment of the invention. Various alterations and changes can be made without departing from the spirit and broader aspects of the invention.

The embodiments of the invention in which an exclusive property or privilege is claimed are defined as follows:

1. A water treatment system comprising:
a base unit;
a filter supported by said base unit;
a UV light assembly supported by said base unit; and
a fluid flow director disposed between said filter and said UV light assembly, said fluid flow director including a substrate layer of plastic and a protective layer substantially opaque to UV light, said substrate layer having a UV-facing surface, said protective layer disposed on at least a portion of said UV-facing surface.

2. A water treatment system as defined in claim 1 wherein said base unit includes:
a top shroud and a bottom shroud that cooperate as housing for said water treatment system;
an electronic module located within said housing for operating said water treatment system;
a power adapter for providing power to said electronic module;
a filter bracket and a collar for seating said filter within said housing; and
tubing that directs the flow of water into and out of said water treatment system;

3. A water treatment system as defined in claim 2 wherein said filter bracket also directs the flow of water in said water treatment system.

4. A water treatment system as defined in claim 2 further including a removable filter cartridge.

5. A water treatment system as defined in claim 4 wherein said filter cartridge includes:
an open end cap and a closed end cap; and
said filter, wherein said filter coaxially interfits with said open end cap and said closed end cap to form a substantially cylindrical ring of space between said UV light assembly and said fluid flow director and a substantially cylindrical ring of space between said fluid flow director and said filter.

6. A water treatment system as defined in claim 5 wherein said filter cartridge further includes a supplemental filter made from a non-woven material, wherein said supplemental filter wraps around said filter.

7. A water treatment system as defined in claim 5 wherein water flows through said tubing through said filter and is directed by said fluid flow director towards said closed end cap, said water flows into said space between said UV light assembly and said fluid flow director for disinfection before being routed out of the water treatment system through said tubing.

8. A water treatment system as defined in claim 2 wherein said tubing includes an inlet water tube and an outlet water tube.

9. A water treatment system as defined in claim 1 wherein said substrate layer of plastic includes ultra-high molecular weight polyethylene.

10. A water treatment system as defined in claim 1 wherein said protective layer includes unexpanded polytetrafluoroethylene.

11. A water treatment system as defined in claim 1 wherein said substrate layer of plastic includes high density polyethylene or low density polyethylene.

12. A water treatment system as defined in claim 1 wherein said protective layer is about 8.5 mills thick.

13. A water treatment system as defined in claim 4 wherein said filter cartridge includes said fluid flow director.

14. A fluid flow director for use in a water treatment system comprising:
a plastic substrate; and
a protective coating that is substantially opaque to UV light.

15. A fluid flow director as defined in claim 14 wherein said plastic substrate includes ultra-high molecular weight polyethylene.

16. A fluid flow director as defined in claim 14 wherein said protective coating includes unexpanded polytetrafluoroethylene.

17. A fluid flow director as defined in claim 14 wherein said plastic substrate includes high density polyethylene or low density polyethylene.

18. A fluid flow director as defined in claim 14 wherein said protective coating is about 8.5 mills thick.

19. A method of manufacturing a water treatment system, comprising the steps of:
providing first and second water treatment assemblies, the second water treatment assembly being a UV water treatment assembly;
providing a fluid flow path between said first and second water treatment assemblies;
providing a fluid flow director with a substrate layer and a protective layer;
positioning the fluid flow director in the fluid flow path between the first water treatment assembly and the second water treatment assembly with the protective layer facing the second water treatment system to protect the substrate layer from UV light emitted by the second water treatment unit.

20. A method of manufacturing a water treatment system as defined in claim 19 wherein said substrate layer of said fluid flow director includes ultra-high molecular weight polyethylene.

21. A method of manufacturing a water treatment system as defined in claim 19 wherein said protective layer of said fluid flow director includes unexpanded polytetrafluoroethylene.
